(19) United States
(12) Patent Application Publication
(10) Pub. No.: US 2012/0019979 A1
(43) Pub. Date: Jan. 26, 2012

(54) OFFSET RISER WIRE

(75) Inventor: John D. Prymak, Greer, SC (US)

(73) Assignee: Kemet Electronics Corporation, Greenville, SC (US)

(21) Appl. No.: 13/249,432

(22) Filed: Sep. 30, 2011

Related U.S. Application Data
(62) Division of application No. 12/323,575, filed on Nov. 26, 2008.
(60) Provisional application No. 60/990,659, filed on Nov. 28, 2007.

(51) Int. Cl. H01G 4/005; B22F 3/12; B22F 7/04; B22F 3/02; B29C 67/02

(52) U.S. Cl. 361/303; 419/66; 264/109; 419/8

(57) ABSTRACT

An anode with a pellet wherein the pellet has a bottom surface. The anode further also has an anode wire with a primary axis and extending beyond the pellet along the primary axis wherein the anode wire has a cross-section perpendicular to the primary axis wherein the cross-section of the anode wire breaches the bottom surface.

### CROSS-REFERENCE TO RELATED APPLICATIONS

The present application claims benefit of pending U.S. Provisional Patent Application No. 60/990,659 filed Nov. 28, 2007 which is incorporated herein by reference.

### BACKGROUND

The present invention is related to an improved capacitor. More particularly, the present invention is related to a capacitor with an offset anode wire.

Capacitors formed from anode pellets are well known in the art. In general, the anode is formed by pressing a powder of a valve metal into a predetermined shape. An anode lead is typically either embedded in the powder prior to pressing or welded to the surface of the pellet after pressing. Embedding the lead is preferable. Dielectric and cathode layers are formed on the anode pellet and the anode lead is then attached to a lead frame, typically, by welding. The distance between the anode lead and lead frame contributes to electrical parasitics such as inductance and resistance. Historically, the level of parasitics has been so low as to be of little significance. As the size of capacitors has decreased and the demand for lower inductance and resistance has increased novel methods of lowering the internal parasitics has been required.

The present invention provides a capacitor, and method of making the capacitor, wherein the internal electrical parasitics are greatly diminished with minimal complication to the manufacturing process.

### SUMMARY

It is an object of the present invention to provide a capacitor comprising a pellet anode wherein the internal electrical parasitics are minimized.

It is another object of the present invention to provide a capacitor wherein the separation between the anode lead and the anode lead frame is reduced.

These and other advantages, as will be realized, are provided in an anode comprising a pellet wherein the pellet has a bottom surface. The anode further comprises an anode wire comprising a primary axis and extending beyond the pellet along the primary axis wherein the anode wire comprises a cross-section perpendicular to the primary axis and wherein the cross-section of the anode wire breaches the bottom surface.

Yet another embodiment is provided in a process for forming an anode comprising the steps of:
inserting a powder into a press;
inserting an anode wire into the powder; and
pressing the powder into a pellet wherein the anode wire breaches a side of the pellet.

Yet another embodiment is provided in a process for forming an anode comprising the steps of:
inserting a powder into a press;
pressing the powder into a pellet; and
attaching an anode wire to a face of the pellet.

### BRIEF SUMMARY OF FIGURES

FIG. 1 schematically illustrates an embodiment of the invention in bottom perspective view.

FIG. 2 schematically illustrates the embodiment of FIG. 1 in side view.

FIG. 3 schematically illustrates an embodiment of the invention in bottom perspective view.

FIG. 4 schematically illustrates the embodiment of FIG. 3 in side view.

FIG. 5 schematically illustrates an embodiment of the invention in bottom perspective view.

FIG. 6 schematically illustrates the embodiment of FIG. 5 in side view.

FIG. 7 schematically illustrates incorporation of an embodiment of the invention onto a lead frame.

FIG. 8 schematically illustrates an embodiment of the invention in exploded side view.

FIG. 9 schematically illustrates an embodiment of the invention in cross-sectional view.

FIG. 10 schematically illustrates the embodiment of FIG. 9 in front view.

FIG. 11 schematically illustrates an embodiment of the invention in cross-sectional view.

FIG. 12 schematically illustrates the embodiment of FIG. 11 in front view.

FIG. 13 schematically illustrates an embodiment of the invention in front view.

### DETAILED DESCRIPTION

The present invention is directed to a capacitor comprising an anode lead wherein the anode lead breaches a surface wherein the breached surface and the long axis of the anode lead are parallel.

The invention will be described with reference to the figures which are integral hereto. The figures represent schematic representations of embodiments of the invention and are provided to facilitate the description without limiting the invention to the figures. In the various figures similar elements will be numbered accordingly.

The preferred structure would have a pellet which is partially fired such that some precursor remains unaltered. The anode lead would be welded to the bottom face with one weld near the edge of the front face of the pellet. After attachment the pellet is further fired.

Anode wires are also referred to in the art as anode leads, anode lead outs, anode risers and similar terms.

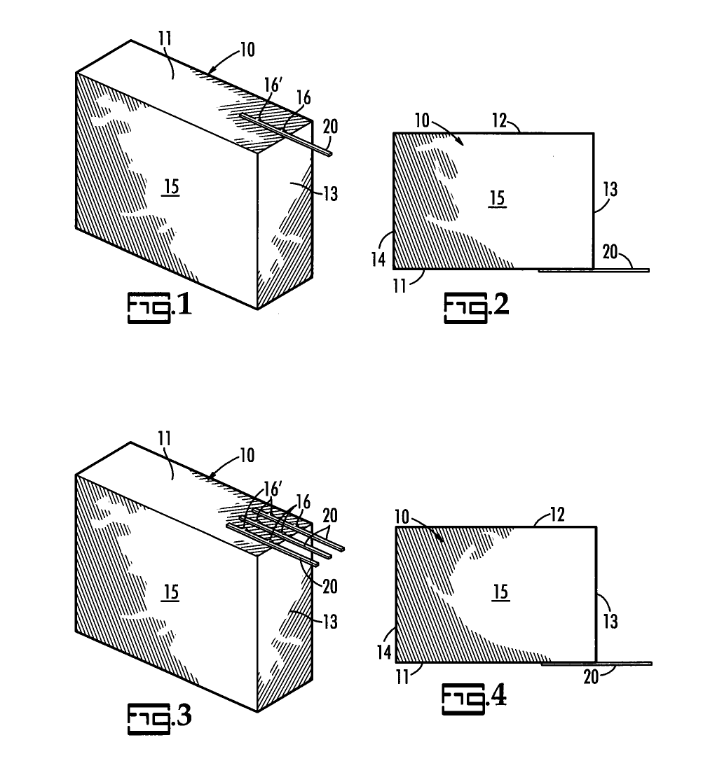

An embodiment of the invention will be described with reference to FIG. 1 wherein a pellet and an anode lead are shown in bottom perspective view and FIG. 2 wherein the same embodiment is shown in side view. In FIGS. 1 and 2 a pellet, 10, having a bottom face, 11, top face, 12, front face, 13, back face, 14, and side faces, 15, is partially sintered. The anode lead is attached to the bottom face and extending beyond the front face. One weld point, 16, is preferably as near the front face as possible within manufacturing tolerance with at least one weld point, 16′, further back away from the front face. Multiple welds between these two points are preferable. The thickness of the subsequent over coating layers including cathode material as well as carbon and silver may make the step increase in height created by the riser wire insignificant. The pellet and wire would then be completely sintered and processed and placed in the facedown package.

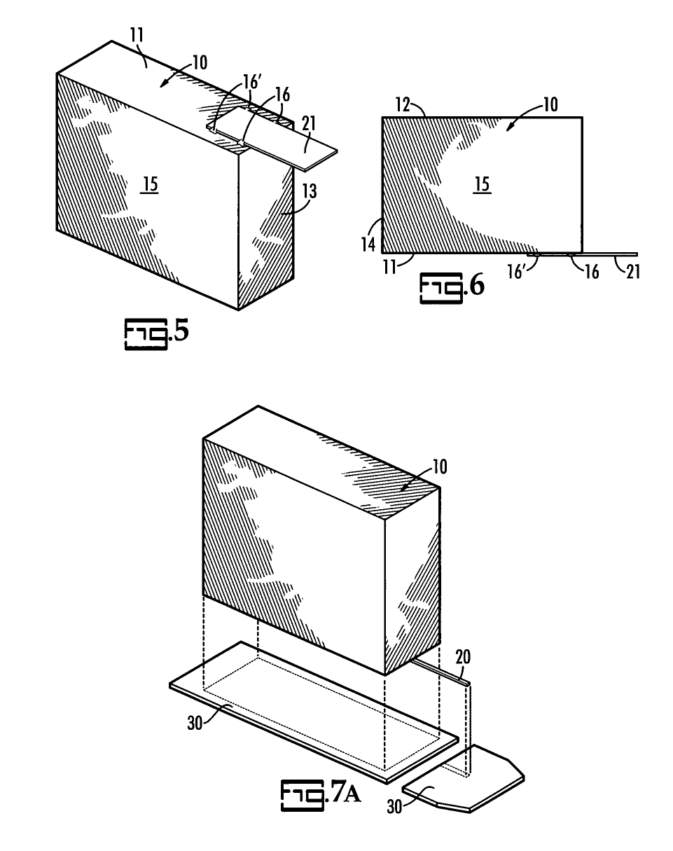

As illustrated in bottom perspective view in FIG. 3 and side view in FIG. 4, multiple anode wires could be attached to bottom face, 11, to improve both the equivalent series resistance (ESR) and equivalent series inductance (ESL) contribution from the multiple anode wires.

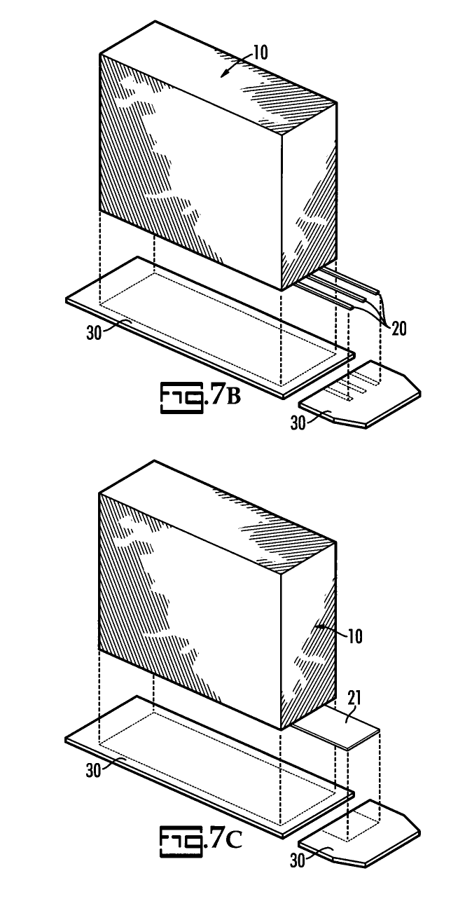

Further reductions in ESR and ESL can be realized by incorporating a flat lead wire, 21, with an aspect ratio of greater than 1 as illustrated in perspective view in FIG. 5 and cross-sectional side view in FIG. 6. In FIGS. 5 and 6 the weld points shown would be the minimum required with allowances made for multiple weld points near and away from the front face edge.

The anode wire can be pressed against the pellet immediately after the pellet is pressed, but the contact between the anode wire and the pellet grains may be smaller than the welded contact leading to breakage and higher ESR.

Three embodiments are illustrated in FIGS. 7A-C as they would be mounted onto a lead frame, 30. Example A illustrates a single anode wire. Example B illustrates multiple anode wires and Example C illustrates an anode wire with an aspect ratio which is higher than 1 which may also be referred to as a ribbon or flat anode wire. In FIGS. 7A-C the pellet is attached to the larger plate using conductive epoxy while the anode wire is welded to the smaller plate. The device is then molded in an epoxy package with only the lead frame plates exposed for surface mounting.

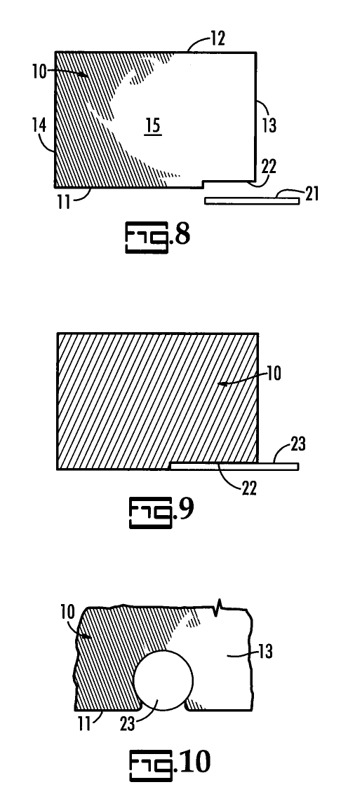

An embodiment is illustrated in FIG. 8. In FIG. 8 the anode wire is received in a notch, 22, on the bottom face, 11, of the pellet, 10. The notch eliminates an offset from the bottom face of the pellet. In a particularly preferred embodiment the notch is at least as deep as the thickness of the anode wire. It is particularly preferred that the bottom face, 11, and lower face of the riser wire, 21, are approximately coplanar.

A particularly preferred embodiment is illustrated in cross-sectional view in FIG. 9 and in front view in FIG. 10. The anode is formed by inserting the anode wire in the die cavity flush against a subsequent bottom face of the pellet. FIGS. 9 and 10 illustrate the embodiment using a round wire, 23. This technique, though advantageous, is not as preferred as other embodiments since the bottom section of the wire would be only partially covered. The effect is worsened as the bottom of the wire is approached and the contact angles with the bottom face decreases creating tighter volumes for the powder to flow.

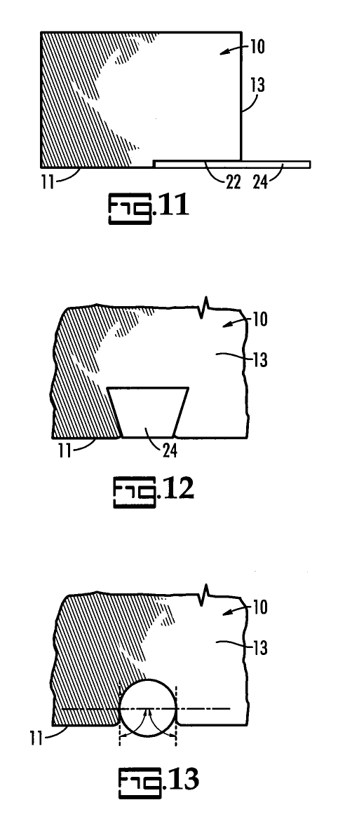

The effects of poor powder flow can be mitigated to a large degree by changing the cross-sectional appearance of the wire from circular to trapezoidal as illustrated in cross-sectional view in FIG. 11 and in front view in FIG. 12. The trapezoidal wire, 24, is placed in the die cavity with the smaller base against the subsequent bottom face, and the larger base exposed away from the bottom face. This results in a larger contact angle between the angled sides of the trapezoid and the subsequent bottom face, allowing less restriction to powder flow to the bottom of the wire. Also, the trapezoidal shape creates a wedged anchor for the wire thereby strengthening the bond. While trapezoidal is a particularly preferred shape other cross-sectional shapes providing an outward convergence are suitable.

Another method for creating this offset riser wire is to press the wire into a pellet that was previously pressed into its shape. Regardless of the shape of the wire, this would leave powder voids approximately parallel to the insertion direction, or 90° in relation to the bottom face plane, to the bottom face of the pellet. Shown in front view in FIG. 13, this may create the weakest bond between the riser wire and the pellet.

In one embodiment it is preferable that the cross-sectional area of the anode wire is not round but is instead somewhat flattened. More preferably, the anode wire has a cross-sectional aspect ratio of greater than 1 and more preferably at least 2.0 to no more than about 100.0. More preferably, the cross-sectional aspect ratio is at least about 4.0. Below a cross-sectional aspect ratio of about 2.0 the properties approach that of a circular cross-section. Above a cross-sectional aspect ratio of about 100.0 the wire becomes structurally weak. The cross-sectional aspect ratio is defined as the ratio of the longest cross-section to the shortest non-parallel cross-section. A square, for example, would have a cross-sectional aspect ratio of 1 and a cross-sectional aspect ratio of 2.0 indicates that the longest cross-sectional dimension is twice the length of the shortest cross-sectional length.

It is particularly preferred that the anode wire breach the bottom face of the anode pellet wherein the bottom face is that face with the anode wire closest thereto. For the purposes of the present invention the face of the anode pellet is breached when the cross-section of the anode wire extends to, or beyond, the plane of the bottom face. It is most preferred that the cross-section of the anode wire extend to the plane but that the furthest extent of the cross-section not extend beyond the plane of the bottom face.

The pressed pellet anode is a conductor preferably selected from a metal or a conductive metal oxide. More preferably the anode comprises a mixture, alloy or conductive oxide of a valve metal preferably selected from Al, W, Ta, Nb, Ti, Zr and Hf. Most preferably the anode comprises at least one material selected from the group consisting of Al, Nb and NbO.

The cathode is a conductor preferably comprising at least one of manganese dioxide and a conductive polymeric material. Particularly preferred conductive polymers include polypyrrole, polyaniline and polythiophene. Metals can be employed as a cathode material with valve metals being less preferred. The cathode may include multiple layers wherein adhesion layers are employed to improve adhesion between the conductor and the termination. Particularly preferred adhesion layers include carbon, silver, copper, or another conductive material in a binder.

The dielectric is a non-conductive layer which is not particularly limited herein. The dielectric may be a metal oxide or a ceramic material. A particularly preferred dielectric is the oxide of a metal anode due to the simplicity of formation and ease of use.

Various aspects of the formation of a pressed pellet anode and capacitor formed thereby are described in U.S. Pat. No. 7,207,103 to Poltorak issued Apr. 24, 2007; U.S. Pat. No. 7,116,548 to Hahn et al. issued Oct. 3, 2006; U.S. patent application Ser. No. 11/542,643 to Hahn et al. filed Sep. 21, 2006 and U.S. Pat. No. 7,154,742 to Hahn et al. issued Dec. 26, 2006 each of which is incorporated herein by reference.

The invention has been described with reference to the preferred embodiments without limit thereto. Based on the description one of skill in the art could derive additional embodiments which are within the meets and bounds of the claims as more specifically set forth in the claims appended hereto.

1-10. (canceled)

11. A process for forming an anode comprising the steps of:
inserting a powder into a press;
inserting an anode wire into said powder; and
pressing said powder into a pellet wherein said anode wire breaches a side of said pellet.

12. The process for forming an anode of claim 11 wherein said anode wire has an aspect ratio of greater than 1 and less than 100.

13. The process for forming an anode of claim 11 wherein said powder comprises at least one material selected from Nb, Ta, NbO, Al, W, Ti, Zr and Hf.

14. The process for forming an anode of claim 13 wherein said powder comprises at least one material selected from Nb, Ta and NbO.

15. The process for forming an anode of claim 14 wherein said powder comprises Nb.

16. The process for forming an anode of claim 11 wherein said anode wire has a trapezoidal cross-section.

17. The process for forming an anode of claim 16 wherein said trapezoidal cross-section comprises two non-parallel faces of equal length and two parallel faces of un-equal length wherein a shorter of said two parallel faces is closer to said side than a longer of said two parallel faces.

18. The process for forming an anode of claim 11 wherein said anode wire has a round cross-section.

19. The process for forming an anode of claim 11 comprising inserting multiple anode wires.

20. A capacitor comprising said anode prepared by the process of claim 11.

21. A process for forming an anode comprising the steps of:
inserting a powder into a press;
pressing said powder into a pellet; and
attaching an anode wire to a face of said pellet.

22. The process for forming an anode of claim 21 wherein said pellet comprises a recess.

23. The process for forming an anode of claim 22 wherein said anode wire is in said recess.

24. The process for forming an anode of claim 21 wherein said anode wire breaches a side of said pellet.

25. The process for forming an anode of claim 21 further comprising partially firing said powder prior to said attaching.

26. The process for forming an anode of claim 25 further comprising additional firing.

27. The process for forming an anode of claim 21 wherein said attaching comprises pressing of said anode wire into said pellet.

28. The process for forming an anode of claim 21 further comprising forming a slot in said pellet.

29. The process for forming an anode of claim 28 further comprising attaching said anode wire to said slot.

30. The process for forming an anode of claim 21 wherein said anode wire has an aspect ratio of greater than 1 and less than 100.

31. The process for forming an anode of claim 21 wherein said powder comprises at least one material selected from Nb, Ta, NbO, Al, W, Ti, Zr and Hf.

32. The process for forming an anode of claim 31 wherein said powder comprises at least one material selected from Nb, Ta and NbO.

33. The process for forming an anode of claim 32 wherein said powder comprises Nb.

34. The process for forming an anode of claim 21 wherein said anode wire has a trapezoidal cross-section.

35. The process for forming an anode of claim 34 wherein said trapezoidal cross-section comprises two non-parallel faces of equal length and two parallel faces of un-equal length wherein a shorter of said two parallel faces is closer to said bottom surface than a longer of said two parallel faces.

36. The process for forming an anode of claim 21 wherein said anode wire has a round cross-section.

37. The process for forming an anode of claim 21 further comprising attaching multiple anode wires to said face.

38. A capacitor comprising an anode formed by the process of claim 21.
